(19) United States
(12) Patent Application Publication
(10) Pub. No.: US 2008/0018564 A1
(43) Pub. Date: Jan. 24, 2008

(54) Plasma display apparatus and method of driving the same

(75) Inventors: Yun Kwon Jung, Gumi-si (KR); Muk Hee Kim, Daegu (KR); Yang Ki An, Chilgok-gun (KR)

Correspondence Address: KED & ASSOCIATES, LLP, P.O. Box 221200, Chantilly, VA, 20153-1200, US

(73) Assignee: LG Electronics Inc.

(21) Appl. No.: 11/638,592

(22) Filed: Dec. 14, 2006

(30) Foreign Application Priority Data
Jul. 18, 2006 (KR) 10 2006-0067130

(51) Int. Cl. G09G 3/28

(52) U.S. Cl. 345/68

(57) ABSTRACT

A plasma display apparatus and a method of driving the same are disclosed. The plasma display apparatus includes a plasma display panel including a first electrode and a second electrode, and a driver. The driver supplies a first sustain signal of a first polarity to the first electrode during a signal supply period. The driver supplies a second sustain signal of a second polarity to the second electrode during at least a portion of the signal supply period. A magnitude of a rising slope and a magnitude of a falling slope of the second sustain signal are less than a magnitude of a rising slope and a magnitude of a falling slope of the first sustain signal, respectively.

This Nonprovisional application claims priority under 35 U.S.C. § 119(a) on Patent Application No. 10-2006-0067130 filed in Korea on Jul. 18, 2006 the entire contents of which are hereby incorporated by reference.

### BACKGROUND

1. Field

This document relates to a plasma display apparatus and a method of driving the same.

2. Description of the Related Art

A plasma display apparatus includes a plasma display panel having a plurality of electrodes, and a driver supplying a predetermined driving signal to the electrodes of the plasma display panel.

The plasma display panel includes a phosphor layer positioned inside discharge cells partitioned by barrier ribs. The driver supplies the driving signal to the discharge cell through the electrodes.

The driving signal supplied to the discharge cell generates a discharge. When the driving signal generates the discharge inside the discharge cells, a discharge gas filled in the discharge cells generates vacuum ultraviolet rays, which thereby cause phosphors formed inside the discharge cells to emit light, thus displaying an image on the screen of the plasma display panel.

The driver supplies driving signals to the electrodes during a reset period, an address period, and a sustain period such that an image is displayed on the plasma display panel.

The reset period is a period for uniforming wall charges accumulated on the electrodes of all the discharge cells. The address period is a period for selecting the discharge cells to be used for light emission among all the discharge cells. The sustain period is a period for emitting light in the discharge cells selected during the address period.

### SUMMARY OF THE INVENTION

In one aspect, a plasma display apparatus comprises a plasma display panel including a first electrode and a second electrode, and a driver that supplies a first sustain signal of a first polarity to the first electrode during a signal supply period, and supplies a second sustain signal of a second polarity to the second electrode during at least a portion of the signal supply period, wherein a magnitude of a rising slope and a magnitude of a falling slope of the second sustain signal are less than a magnitude of a rising slope and a magnitude of a falling slope of the first sustain signal, respectively.

In another aspect, a method of driving a plasma display apparatus including a first electrode and a second electrode, comprises supplying a first sustain signal of a first polarity to the first electrode during a signal supply period, and supplying a second sustain signal of a second polarity to the second electrode during at least a portion of the signal supply period, wherein a magnitude of a rising slope and a magnitude of a falling slope of the second sustain signal are less than a magnitude of a rising slope and a magnitude of a falling slope of the first sustain signal, respectively.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a plasma display apparatus according to one embodiment;

FIG. 2 illustrates a plasma display panel of the plasma display apparatus according to one embodiment;

FIG. 3 illustrates a method for representing a gray level in the plasma display apparatus according to one embodiment;

FIG. 4 illustrates a driving signal generated in the plasma display apparatus according to one embodiment;

FIGS. 5a and 5b illustrate another form of a rising signal or a second falling signal;

FIG. 6 illustrates a first sustain signal and a second sustain signal;

FIG. 7a illustrates a case of supplying only a first sustain signal;

FIG. 7b illustrates a case of simultaneously supplying a first sustain signal and a second sustain signal;

FIG. 8 illustrates a slope of a second sustain signal;

FIG. 9 illustrates a second sustain signal, which a driver of the plasma display apparatus according to one embodiment supplies selectively;

FIG. 10 illustrates a second sustain signal, which a driver of the plasma display apparatus according to one embodiment selectively supplies for each subfield;

FIG. 11 illustrates a driver of the plasma display apparatus according to one embodiment;

FIG. 12 illustrates an operation of a driver of the plasma display apparatus according to one embodiment; and

FIG. 13 illustrates a first sustain signal and a second sustain signal which a driver of the plasma display apparatus according to one embodiment supplies.

### DETAILED DESCRIPTION OF PREFERRED EMBODIMENTS

Preferred embodiments of the present invention will be described in a more detailed manner with reference to the drawings.

A plasma display apparatus comprises a plasma display panel including a first electrode and a second electrode, and a driver that supplies a first sustain signal of a first polarity to the first electrode during a signal supply period, and supplies a second sustain signal of a second polarity to the second electrode during at least a portion of the signal supply period, wherein a magnitude of a rising slope and a magnitude of a falling slope of the second sustain signal are less than a magnitude of a rising slope and a magnitude of a falling slope of the first sustain signal, respectively.

The width of the second sustain signal may be less than the width of the first sustain signal.

A supply time point of the second sustain signal may be later than a supply time point of the first sustain signal, and a time interval between the supply time point of the first sustain signal and the supply time point of the second sustain signal may be equal to or more than 50 μs.

A supply time point of the second sustain signal may be later than a supply time point of the first sustain signal, and a time interval between the supply time point of the first sustain signal and the supply time point of the second sustain signal may be equal to or more than 100 μs.

The highest voltage of the first sustain signal may range from 120V to 180V.

The lowest voltage of the first sustain signal may range from −180V to −120V.

The lowest voltage of the second sustain signal may range from −60V to −40V.

The highest voltage of the second sustain signal may range from 40V to 60V.

The magnitude of the rising slope of the second sustain signal may be different from the magnitude of the falling slope of the second sustain signal.

The magnitude of the rising slope of the second sustain signal may be less than the magnitude of the falling slope of the second sustain signal.

The plasma display apparatus may further comprise a third electrode receiving a data signal, wherein a magnitude of the lowest voltage of the second sustain signal may be substantially equal to a magnitude of the highest voltage of the data signal.

The driver may supply a third sustain signal of the first polarity to one electrode of the first electrode and the second electrode, and may supply a ground level voltage to the other electrode.

The driver may supply the first sustain signal and the second sustain signal in a first subfield of a frame. The driver may supply a third sustain signal of the first polarity to one of the first electrode and the second electrode, and a ground level voltage to the other electrode in a second subfield of the frame.

The number of first sustain signals supplied during a sustain period of the first subfield may be smaller than the number of third sustain signals supplied during a sustain period of the second subfield.

The driver may include a first energy recovery unit that recovers a first voltage of the first polarity from one electrode of the first electrode and the second electrode, and supplies the first voltage to one electrode, a first resonance unit that forms resonance when recovering or supplying the first voltage from or to one electrode, a first voltage supply unit that supplies a sustain voltage to one electrode associated with the first energy recovery unit, a second voltage supply unit that supplies the lowest voltage of the second sustain signal, a second energy recovery unit that recover a second voltage of the second polarity from the other electrode or supplies the second voltage to the other electrode, a second resonance unit that forms resonance when recovering or supplying the second voltage from or to the other electrode, a ground controller that grounds the first electrode or the second electrode, and a path forming unit that forms a supply path of the second sustain signal and a supply path of a ground level voltage.

The first resonance unit and the second resonance unit each may include a first inductor and a second inductor, and inductance of the second inductor may be more than inductance of the first inductor.

The ground controller may include a diode whose a cathode terminal is grounded, and a switch connected in parallel to the diode.

The second resonance unit may include a recovery inductor for recovering the second voltage and a supply inductor for supplying the second voltage, and inductance of the supply inductor may be less than inductance of the recovery inductor.

The driver may alternately supply the first sustain signal of the first polarity and a third sustain signal of the second polarity to the first electrode. The driver may alternately supply the second sustain signal of the second polarity and a fourth sustain signal of the first polarity to the second electrode.

A method of driving a plasma display apparatus including a first electrode and a second electrode, comprises supplying a first sustain signal of a first polarity to the first electrode during a signal supply period, and supplying a second sustain signal of a second polarity to the second electrode during at least a portion of the signal supply period, wherein a magnitude of a rising slope and a magnitude of a falling slope of the second sustain signal are less than a magnitude of a rising slope and a magnitude of a falling slope of the first sustain signal, respectively.

Hereinafter, exemplary embodiments of the present invention will be described in detail with reference to the attached drawings.

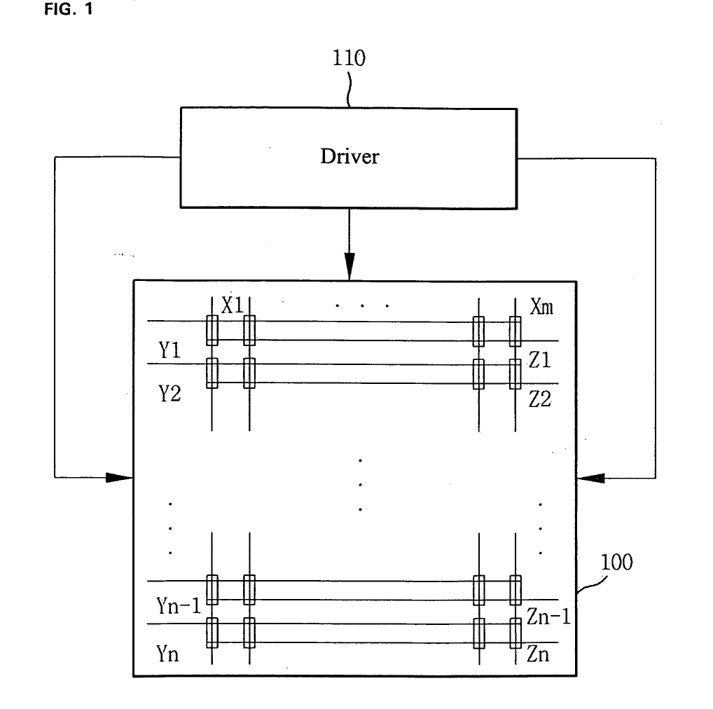

FIG. 1 illustrates a plasma display apparatus according to one embodiment. As illustrated in FIG. 1, the plasma display apparatus according to one embodiment includes a plasma display panel 100 and a driver 110.

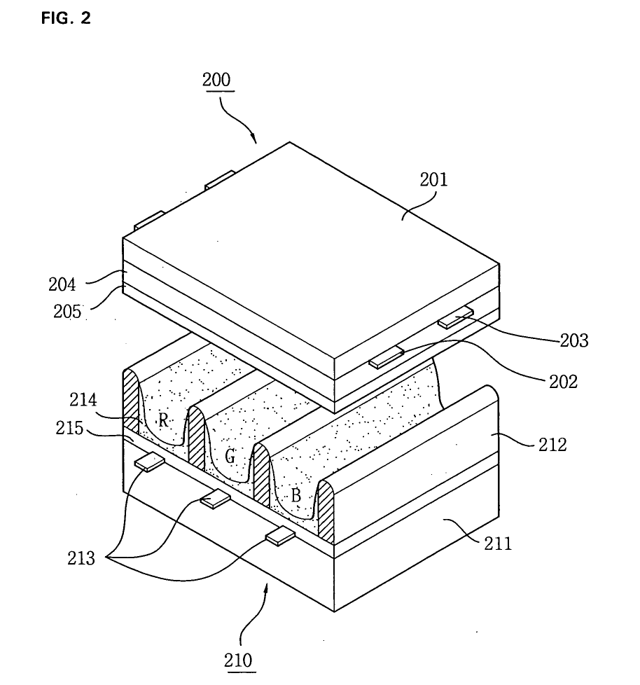

One example of the plasma display panel 100 of FIG. 1 is illustrated in detail with reference to FIG. 2.

As illustrated in FIG. 2, the plasma display panel includes a front panel 200 and a rear panel 210. The front panel 200 includes a front substrate 201 on which a scan electrode 202 and a sustain electrode 203 are formed. The rear panel 210 includes a rear substrate 211 on which an address electrode 213 is formed to intersect the scan electrode 202 and the sustain electrode 203.

A driving signal is supplied to the scan electrode 202 and the sustain electrode 203 during a reset period, an address period, and a sustain period. This results in the generation of a reset discharge for uniforming wall charges of all discharge cells, an address discharge for selecting the discharge cells to be used for light emission among all the discharge cells, and a sustain discharge for emitting light in the selected discharge cells.

An upper dielectric layer 204 is formed on an upper portion of the front substrate 201 on which the scan electrode 202 and the sustain electrode 203 are formed. The upper dielectric layer 204 provides insulation between the scan electrode 202 and the sustain electrode 203.

A protective layer 205 is formed on an upper surface of the upper dielectric layer 204 to facilitate discharge conditions.

The address electrode 213 positioned on the rear substrate 211 is supplied with a data signal for selecting the discharge cells during the address period.

A lower dielectric layer 215 is formed on an upper portion of the rear substrate 211 on which the address electrode 213 is formed. The lower dielectric layer 215 provides insulation of the address electrode 213.

Barrier ribs 212 are formed on an upper portion of the lower dielectric layer 215 to partition the discharge cells. The barrier ribs 212 have various forms such as a stripe type, a well type, a delta type, a honeycomb type. Each discharge cell partitioned by the barrier ribs 212 is filled with a predetermined discharge gas.

Red (R), green (G) and blue (B) phosphor layers 114 for emitting visible light are formed inside the discharge cells partitioned by the barrier ribs 212.

A black layer (not illustrated) may be formed on an upper portion of the barrier rib 212 to prevent the reflection of external light caused by the barrier rib 212.

The driver 110 of FIG. 1 supplies a first sustain signal of a first polarity to the scan electrode during the sustain period, and supplies a second sustain signal of a second polarity to the sustain electrode during at least a portion of the sustain period. A magnitude of a rising slope and a magnitude of a falling slope of the second sustain signal are less than a magnitude of a rising slope and a magnitude of a falling slope of the first sustain signal.

The driver 110 of FIG. 1 may be formed on one board or a plurality of boards. For example, the driver 110 may include a driving board installing a circuit for driving the scan electrode, a driving board installing a circuit for driving the sustain electrode, and a driving board installing a circuit for driving the address electrode.

An operation of the driver 110 will be described in detail later.

The following is a detailed description of a method for representing a gray level and a driving signal in the plasma display apparatus according to one embodiment.

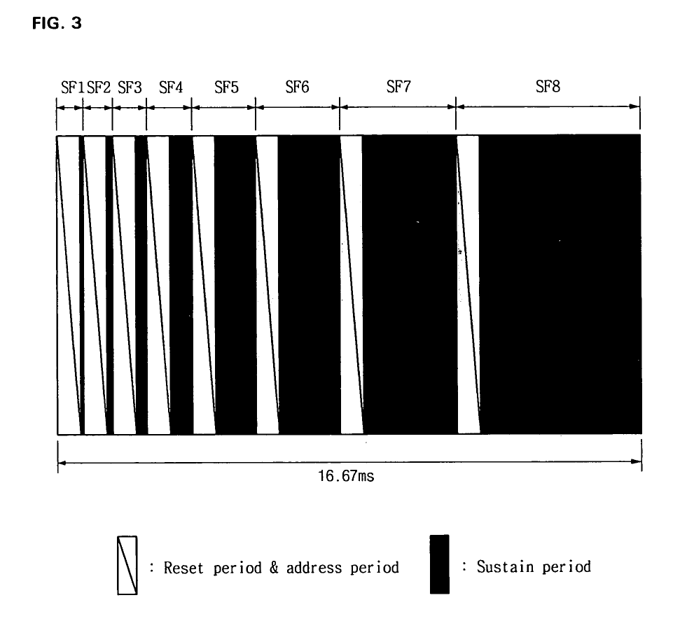

FIG. 3 illustrates a method for representing a gray level in the plasma display apparatus according to one embodiment.

Referring to FIG. 3, the plasma display apparatus according to one embodiment displays an image with a frame being divided into several subfields having a different number of emission times. Each subfield is subdivided into a reset period for initializing all the cells, an address period for selecting cells to be discharged, and a sustain period for representing gray level in accordance with the number of discharges.

For example, if an image with 256-level gray level is to be displayed, a frame, a frame (i.e., 16.67 ms) corresponding to 1/60 sec is divided into 8 subfields SF1 to SF8. SF8. Each of the 8 subfields SF1 to SF8 is subdivided into a reset period, an address period and a sustain period.

The number of sustain signals supplied during the sustain period determines gray level weight in each of the subfields. For example, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

Although FIG. 3 has illustrated and described a case where one frame includes 8 subfields, the number of subfields constituting one frame may vary. For example, one frame may include 12 subfields or 10 subfields.

Further, although FIG. 3 has illustrated and described the subfields arranged in increasing order of gray level weight, the subfields may be arranged in decreasing order of gray level weight, or the subfields may be arranged regardless of gray level weight.

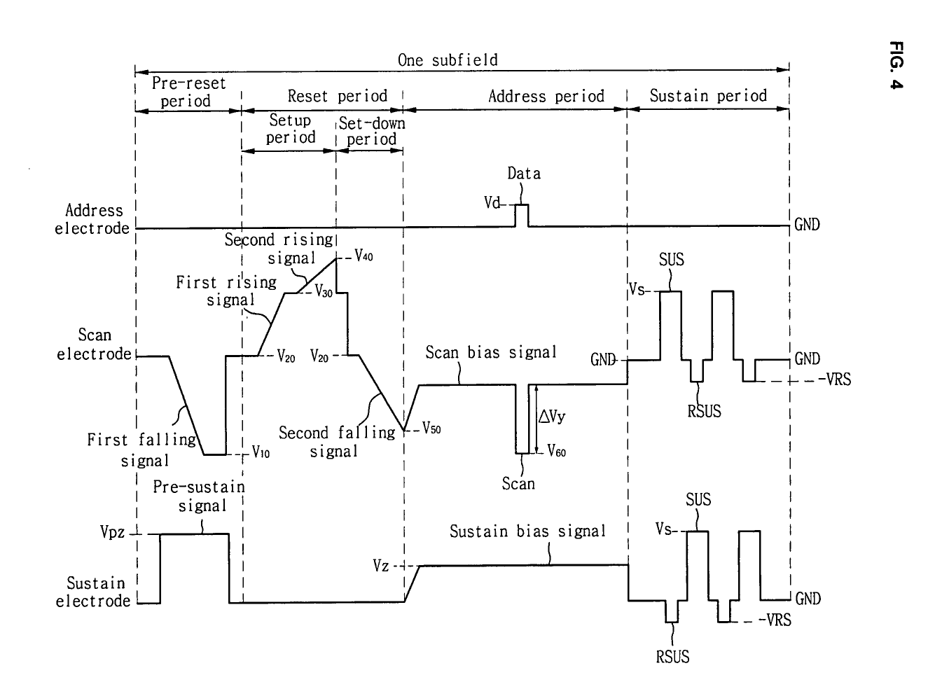

FIG. 4 illustrates a driving signal generated in the plasma display apparatus according to one embodiment.

During a pre-reset period prior to a reset period, the driver 110 of FIG. 1 supplies a first falling signal to a scan electrode Y, and a pre-sustain signal to a sustain electrode Z. The first falling signal gradually falls from a ground level voltage GND to a voltage V10. The pre-sustain signal rises from the ground level voltage GND to a voltage Vpz. The voltage Vpz is substantially equal to the highest voltage Vs of a first sustain signal (SUS) which will be supplied during a sustain period.

As above, the first falling signal is supplied to the scan electrode Y and the pre-sustain signal is supplied to the sustain electrode Z during the pre-reset period such that positive wall charges are accumulated on the scan electrode Y and negative wall charges are accumulated on the sustain electrode Z. As a result, a setup discharge of a sufficiently strength occurs during the reset period. Furthermore, although the highest voltages of a first rising signal and a second rising signal supplied to the scan electrode Y during the reset period are low, a setup discharge of a sufficiently strength occurs.

At least one of a plurality of subfields constituting a frame may include a pre-reset period. Each subfield may not include the pre-reset period.

The reset period is further divided into a setup period and a set-down period. During the setup period, the driver 110 of FIG. 1 supplies a first rising signal gradually rising from a voltage V20 to a voltage V30, and a second rising signal gradually rising from the voltage V30 to a voltage V40 to the scan electrode Y. The first rising signal and the second rising signal generate a weak dark discharge, i.e., a setup discharge. A slope of the second rising signal may be less than a slope of the first rising signal. The voltage of the rising signal rises relatively rapidly until the setup discharge occurs, and the voltage of the rising signal rises relatively slowly during the generation of the setup discharge. This results in a reduction in the quantity of light generated by the setup discharge. Accordingly, contrast of the plasma display apparatus is improved.

During the set-down period, the driver 110 of FIG. 1 supplies a second falling signal gradually falling from the voltage V20 to a voltage V50 to the scan electrode Y. The second falling signal generates a weak erase discharge (i.e., a set-down discharge) inside the discharge cell. Thus, the remaining wall charges are uniform inside the discharge cells.

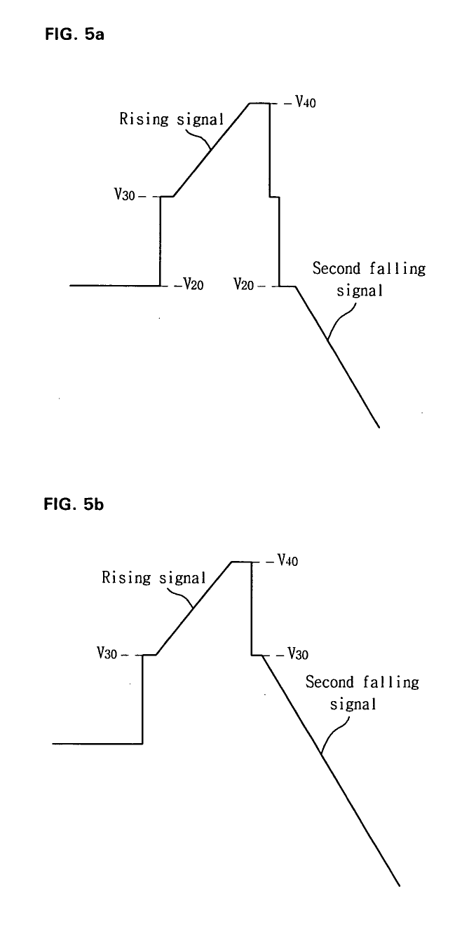

The driver 110 of FIG. 1 may supply a driving signal different from the first rising signal, the second rising signal or the second falling signal of FIG. 4. This will be described in detail below with reference to FIGS. 5a and 5b.

FIGS. 5a and 5b illustrate another form of a rising signal or a second falling signal.

As illustrated in FIG. 5a, a rising signal may rise to the voltage V30, and then may gradually rise from the voltage V30 to the voltage V40. As illustrated in FIG. 5b, the second falling signal may fall from the voltage V30.

Referring again to FIG. 4, during the address period, the driver 110 of FIG. 1 supplies a scan bias signal to the scan electrode Y. The highest voltage of the scan bias signal is higher than the voltage V50 of the second falling signal.

The driver 110 supplies a scan signal (Scan) falling from the scan bias signal to a voltage V60 to all the scan electrodes Y. A difference between the highest voltage of the scan bias signal and the voltage V60 is equal to Δvy.

The driver 110 supplies a data signal (Data) synchronized with the scan signal (Scan) to the address electrode X. As a difference between the voltage V60 of the scan signal (Scan) and a voltage Vd of the data signal (Data) is added to a wall voltage generated during the reset period, the address discharge is generated within the discharge cells to which the voltage Vd is supplied.

The driver 110 supplies a sustain bias signal to the sustain electrode Z during the address period to prevent the generation of the unstable address discharge by interference of the sustain electrode Z. The highest voltage Vz of the sustain bias signal may be lower than the highest voltage of a first sustain signal, and may be higher than the ground level voltage GND.

During the sustain period, the driver 110 alternately supplies a first sustain signal (SUS) of a first polarity to the scan electrode Y and the sustain electrode Z. The highest voltage of the first sustain signal (SUS) is equal to Vs. During at least a portion of the sustain period, the driver 110 alternately supplies a second sustain signal (RSUS) of a second polarity to the scan electrode Y and the sustain electrode Z.

As the first sustain signal (SUS) and the second sustain signal (RSUS) are supplied the scan electrode Y and the sustain electrode Z, a wall voltage inside the discharge cells selected by performing the address discharge, the highest voltage Vs of the first sustain signal (SUS), and the lowest voltage −VRS of the second sustain signal (RSUS) generate a sustain discharge between the scan electrode Y and the sustain electrode Z. Thus, a predetermined image is displayed on the plasma display panel. A magnitude of a rising slope and a magnitude of a falling slope of the second sustain signal (RSUS) are less than a magnitude of a rising slope and a magnitude of a falling slope of the first sustain signal (SUS), respectively.

The first sustain signal (SUS) and the second sustain signal (RSUS) will be described in detail below.

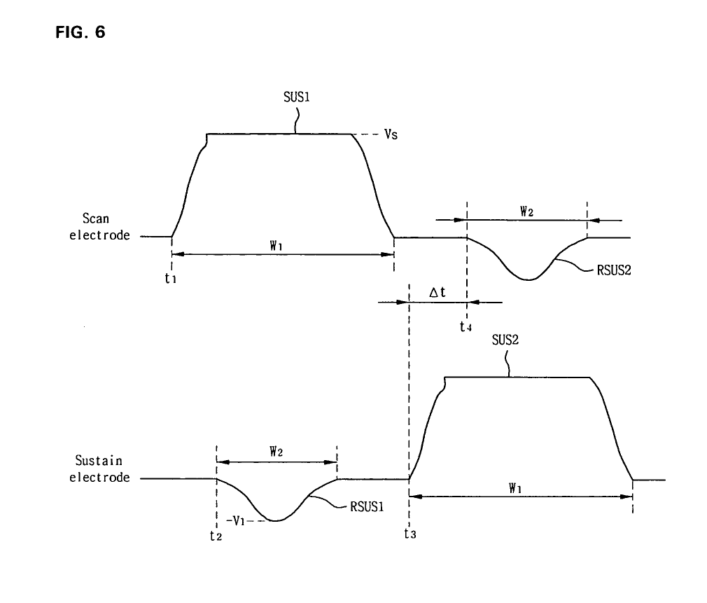

FIG. 6 illustrates a first sustain signal and a second sustain signal. As illustrated in FIG. 6, the driver 110 of FIG. 1 supplies a first sustain signal SUS1 to the scan electrode Y, and a second sustain signal RSUS1 to the sustain electrode Z during the sustain period. During a portion duration W2 of a duration W1 of the supplying of the first sustain signal SUS1 to the scan electrode Y, the second sustain signal RSUS1 is supplied to the sustain electrode Z.

Afterwards, the driver 110 supplies a first sustain signal SUS2 to the sustain electrode Z, and a second sustain signal RSUS2 to the scan electrode Y. During a portion duration W2 of a duration W1 of the supplying of the first sustain signal SUS2 to the sustain electrode Z, the second sustain signal RSUS2 is supplied to the scan electrode Y.

Supply time points t2 and t4 of the second sustain signals RSUS1 and RSUS2 may be later than supply time points t1 and t3 of the first sustain signals SUS1 and SUS2, respectively.

A magnitude of a rising slope and a magnitude of a falling slope of the second sustain signals RSUS1 and RSUS2 are less than a magnitude of a rising slope and a magnitude of a falling slope of the first sustain signals SUS1 and SUS2, respectively.

The rising slope of the second sustain signals RSUS1 and RSUS2 is defined as a ratio of a voltage difference between the lowest voltage −V1 and the highest voltage of the second sustain signals RSUS1 and RSUS2 to time required in rising from the lowest voltage −V1 to the highest voltage of the second sustain signals RSUS1 and RSUS2. The falling slope of the second sustain signals RSUS1 and RSUS2 is defined as a ratio of the voltage difference between the lowest voltage −V1 and the highest voltage of the second sustain signals RSUS1 and RSUS2 to time required in falling from the highest voltage to the lowest voltage −V1 of the second sustain signals RSUS1 and RSUS2. Further, the rising slope of the first sustain signals SUS1 and SUS2 is defined as a ratio of a voltage difference between the lowest voltage and the highest voltage Vs of the first sustain signals SUS1 and SUS2 to time required in rising from the lowest voltage to the highest voltage Vs of the first sustain signals SUS1 and SUS2. The falling slope of the first sustain signals SUS1 and SUS2 is defined as a ratio of a voltage difference between the lowest voltage and the highest voltage Vs of the first sustain signals SUS1 and SUS2 to time required in falling from the highest voltage Vs to the lowest voltage of the first sustain signals SUS1 and SUS2.

A reason to supply the first sustain signal and the second sustain signal in one embodiment will be described in detail below.

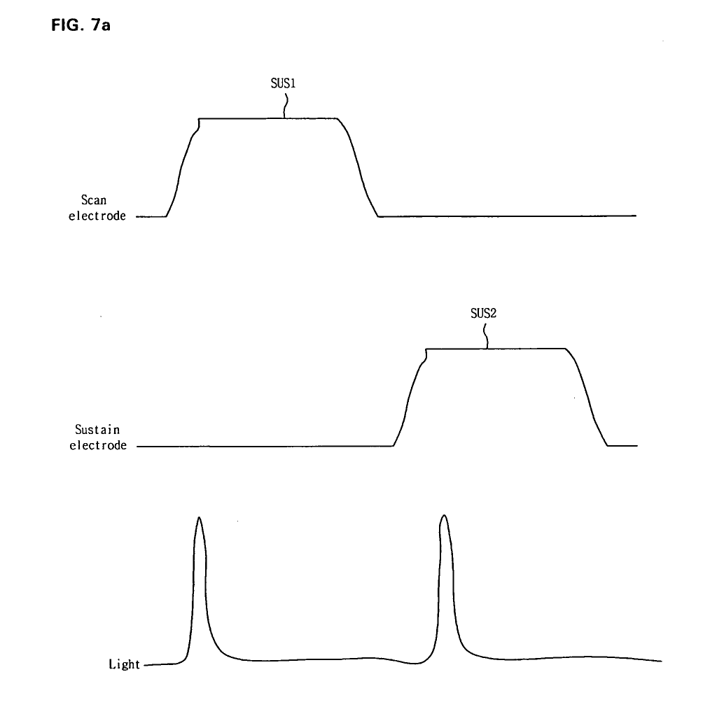

FIG. 7a illustrates a case of supplying only a first sustain signal, and FIG. 7b illustrates a case of simultaneously supplying a first sustain signal and a second sustain signal.

As illustrated in FIG. 7a, when the first sustain signals SUS1 and SUS2 are alternately supplied to the scan electrode Y and the sustain electrode Z, light is generated around a time point of the supplying of the first sustain signal SUS1 to the scan electrode Y, and light is generated around a time point of the supplying of the first sustain signal SUS2 to the sustain electrode Z.

As illustrated in FIG. 7b, the first sustain signal SUS1 and the second sustain signal RSUS2 are supplied to the scan electrode Y, and the second sustain signal RSUS1 and the first sustain signal SUS2 are supplied to the sustain electrode Z.

Light is generated around a time point of the supplying of the first sustain signal SUS1 to the scan electrode Y, and a discharge generated by the first sustain signal SUS1 is maintained by the second sustain signal RSUS1 supplied to the sustain electrode Z. Therefore, light is generated during the supplying of the second sustain signal RSUS1.

When a magnitude of the falling slope of the second sustain signal RSUS1 is more than a magnitude of the rising slope of the first sustain signal SUS1, an excessively great discharge occurs at a time when the second sustain signal RSUS1 is supplied. Therefore, there is a likelihood of a reduction in wall charges for maintaining the discharge. To prevent the likelihood, the magnitude of the falling slope of the second sustain signal RSUS1 is less than a magnitude of the rising slope of the first sustain signal SUS1 in one embodiment.

Light is generated around a time point of the supplying of the first sustain signal SUS1 to the sustain electrode Z, and a discharge generated by the first sustain signal SUS1 is maintained by the second sustain signal RSUS1 supplied to the scan electrode Y. Therefore, light is generated during the supplying of the second sustain signal RSUS2. Accordingly, since the quantity of generated light increases, the driving efficiency increase.

To more efficiently maintain discharges generated by the first sustain signals SUS1 and SUS2 of FIG. 6 using the second sustain signals RSUS1 and RSUS2, the second sustain signals RSUS1 and RSUS2 may be supplied after sufficiently maintaining the discharges generated by the first sustain signals SUS1 and SUS2.

Accordingly, the supply time points t2 and t4 of the second sustain signals RSUS1 and RSUS2 may be later than the supply time points t1 and t3 of the first sustain signals SUS1 and SUS2, respectively.

A time interval Δt between the supply time points t2 and t4 of the second sustain signals RSUS1 and RSUS2 and the supply time points t1 and t3 of the first sustain signals SUS1 and SUS2 may be equal to or more than 50 μs. Preferably, the time interval Δt may be equal to or more than 100 μs.

Since the second sustain signals RSUS1 and RSUS2 are supplied during the supplying of the first sustain signals SUS1 and SUS2, the highest voltages of the first sustain signals SUS1 and SUS2 may be reduced. For example, when the second sustain signals RSUS1 and RSUS2 are not supplied, the highest voltages of the first sustain signals SUS1 and SUS2 may be equal to 200V. On the other hand, when the second sustain signals RSUS1 and RSUS2 are supplied, the highest voltages of the first sustain signals SUS1 and SUS2 may be less than 200V.

The highest voltage Vs of the first sustain signals SUS1 and SUS2 may range from about 120V to about 180V. The lowest voltage −V1 of the second sustain signals RSUS1 and RSUS2 may range from about −60V to about −40V.

A magnitude of the lowest voltage −V1 of the second sustain signals RSUS1 and RSUS2 may be substantially equal to a magnitude of the highest voltage Vd of the data signal (Data) of FIG. 4. Thus, since the lowest voltage −V1 of the second sustain signals RSUS1 and RSUS2 is supplied without installing an additional circuit, an increase in the manufacturing cost is prevented.

Since the first sustain signals SUS1 and SUS2 are supplied and then the second sustain signals RSUS1 and RSUS2 are supplied, the voltage difference between the scan electrode and the sustain electrode increases during the sustain period. Accordingly, an erroneous discharge between the scan electrode and the address electrode or an erroneous discharge between the sustain electrode and the address electrode are prevented. Even if a distance between the scan electrode and the sustain electrode is wide, an erroneous discharge between the scan electrode and the address electrode or an erroneous discharge between the sustain electrode and the address electrode are prevented during the sustain period.

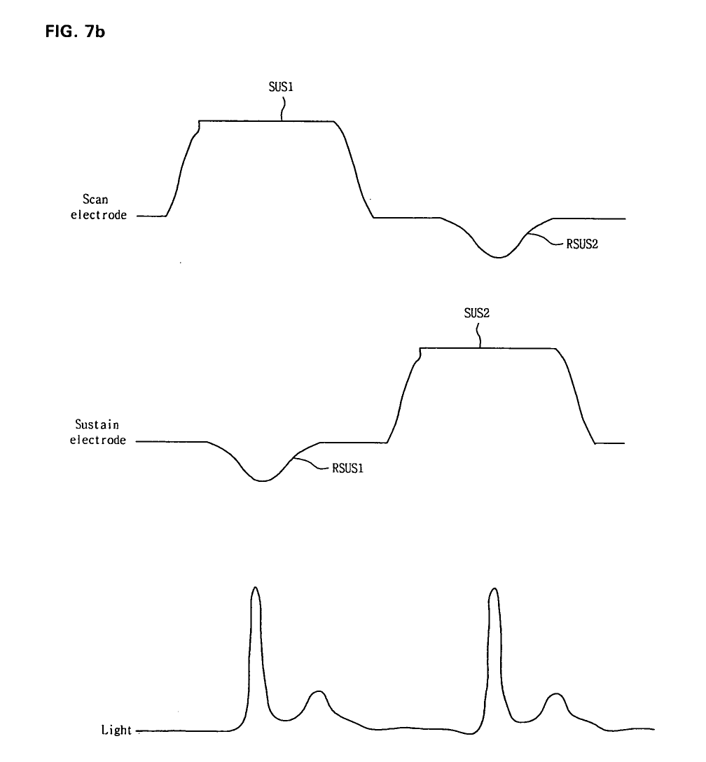

FIG. 8 illustrates a slope of a second sustain signal. As illustrated in FIG. 8, a magnitude of a rising slope of the second sustain signal RSUS in a rising period may be different from a magnitude of a falling slope of the second sustain signal RSUS in a falling period. For example, the magnitude of the rising slope of the second sustain signal RSUS may be less than the magnitude of the falling slope of the second sustain signal RSUS.

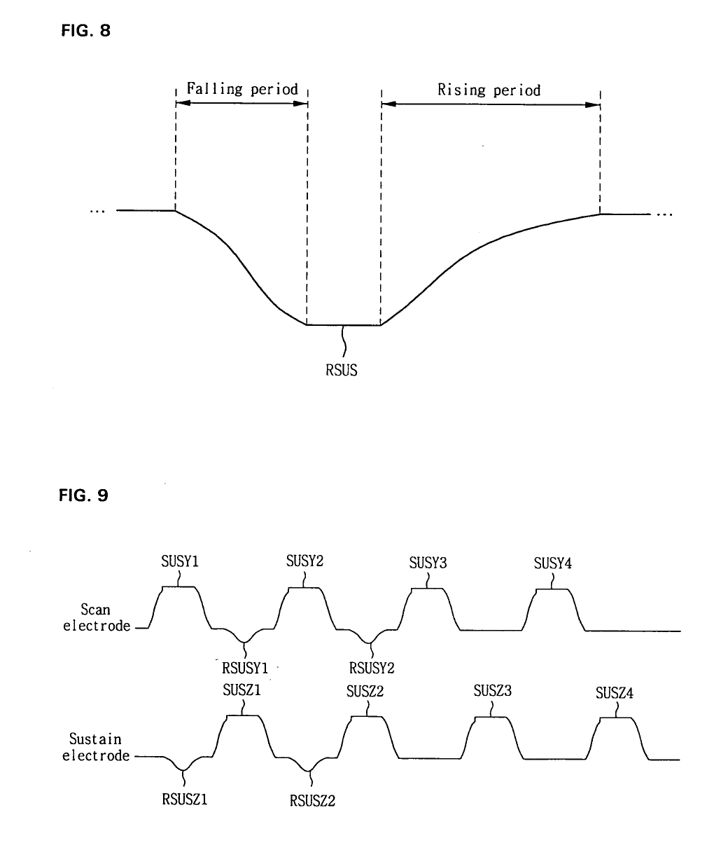

The driver 110 may selectively supply the second sustain signal in the same way as FIG. 9.

FIG. 9 illustrates a second sustain signal, which a driver of the plasma display apparatus according to one embodiment supplies selectively.

As illustrated in FIG. 9, the driver 110 supplies first sustain signals SUSY1, SUSY2, SUSZ1 and SUSZ2 and third sustain signals SUSY3, SUSY4, SUSZ3 and SUSZ4 to the scan electrode and the sustain electrode.

The driver 110 supplies second sustain signals RSUSZ1 and RSUSZ2 corresponding to the first sustain signals SUSY1 and SUSY2 to the sustain electrode, and supplies the ground level voltage corresponding to the third sustain signals SUSY3 and SUSY4 to the sustain electrode. The driver 110 supplies second sustain signals RSUSY1 and RSUSY2 corresponding to the first sustain signals SUSZ1 and SUSZ2 to the scan electrode, and supplies the ground level voltage corresponding to the third sustain signals SUSZ3, SUSZ4 to the scan electrode.

It is possible to selectively supply the second sustain signals for each subfield.

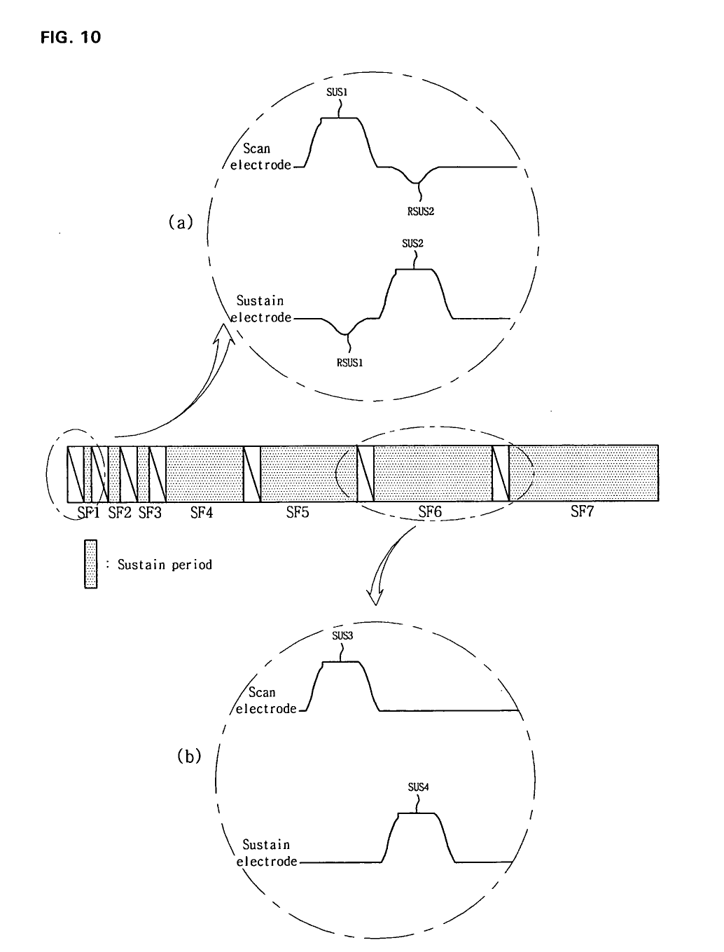

FIG. 10 illustrates a second sustain signal, which a driver of the plasma display apparatus according to one embodiment selectively supplies for each subfield.

As illustrated in FIG. 10, it is assumed that one frame includes a total of 7 subfields SF1 to SF7, and the 7 subfields SF1 to SF7 are arranged in increasing order of gray level weight.

As illustrated in (a) of FIG. 10, the driver 110 supplies a first sustain signal SUS1 to the scan electrode, and a second sustain signal RSUS1 to the sustain electrode in the first subfield SF1 having the lowest gray level weight. Further, the driver 110 supplies a first sustain signal SUS2 to the sustain electrode, and a second sustain signal RSUS2 to the scan electrode in the first subfield SF1. On the other hand, as illustrated in (b) of FIG. 10, the driver 110 supplies the ground level voltage corresponding to third sustain signals SUS3 and SUS4 to the scan electrode and the sustain electrode in the sixth subfield SF6 having gray level weight that is more than the gray level weight of the first subfield SF1. Therefore, the number of sustain signals supplied during a sustain period of the first subfield SF1 is smaller than the number of sustain signals supplied during a sustain period of the sixth subfield SF6. Since the gray level weight of the first subfield SF1 is less than the gray level weight of the sixth subfield SF6, the number of the first sustain signals SUS1 and SUS2 supplied during the sustain period of the first subfield SF1 is smaller than the number of the third sustain signals SUS3 and SUS4 supplied during the sustain period of the sixth subfield SF6.

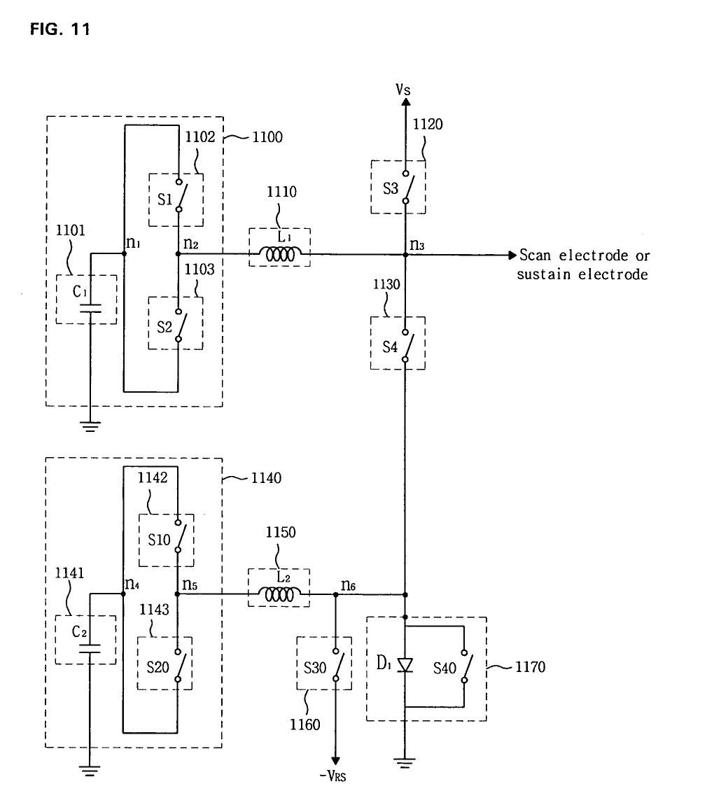

FIG. 11 illustrates a driver of the plasma display apparatus according to one embodiment. As illustrated in FIG. 11, the driver of the plasma display apparatus according to one embodiment includes a first energy recovery unit 1100, a first resonance unit 1110, a first voltage supply unit 1120, a second energy recovery unit 1140, a second resonance unit 1150, a ground controller 1170, and a path forming unit 1130.

When supplying a first sustain signal SUS, the first energy recovery unit 1100 recovers energy from the scan electrode or the sustain electrode, or supplies a voltage previously stored in the first energy recovery unit 1100 to the scan electrode or the sustain electrode. The first energy recovery unit 1100 includes a first voltage storing unit 1101, a first supply unit 1102, and a first voltage recovery unit 1103.

The first voltage storing unit 1101 includes a first capacitor C1 for storing energy corresponding to a predetermined voltage.

The first supply unit 1102 includes a first control switch S1. A turn-on operation of the first control switch S1 occurs the supplying of the energy stored in the first voltage storing unit 1101 to the scan electrode or the sustain electrode of the plasma display panel.

The first voltage recovery unit 1103 includes a second control switch S2. The energy recovered from the scan electrode or the sustain electrode of the plasma display panel is stored in the first voltage storing unit 1101 through a turn-on operation of the second control switch S2.

When supplying a second sustain signal RSUS, the second energy recovery unit 1140 recovers energy from the scan electrode or the sustain electrode, or supplies a voltage previously stored in the second energy recovery unit 1140 to the scan electrode or the sustain electrode. The second energy recovery unit 1140 includes a second voltage storing unit 1141, a second supply unit 1142, and a second voltage recovery unit 1143.

The second voltage storing unit 1141 includes a second capacitor C2 for storing energy corresponding to a predetermined voltage.

The second supply unit 1142 includes a tenth control switch S10. A turn-on operation of the tenth control switch S10 occurs the supplying of the energy stored in the second voltage storing unit 1141 to the scan electrode or the sustain electrode of the plasma display panel.

The second voltage recovery unit 1143 includes a twentieth control switch S20. The energy recovered from the scan electrode or the sustain electrode of the plasma display panel is stored in the second voltage storing unit 1141 through a turn-on operation of the twentieth control switch S20.

The first resonance unit 1110 includes a first resonance inductor L1, and forms a resonance circuit when supplying or recovering the energy. The second resonance unit 1150 includes a second resonance inductor L2, and forms a resonance circuit when supplying or recovering the energy.

Inductance of the second resonance unit 1150 may be more than inductance of the first resonance unit 1110. When the inductance of the second resonance unit 1150 is more than the inductance of the first resonance unit 1110, a magnitude of a slope of the second sustain signal RSUS becomes smaller than a magnitude of a slope of the first sustain signal SUS.

If the second resonance unit 1150 includes inductors (not illustrated) having different inductances on a voltage recovery path and a voltage supply path, as illustrated in FIG. 8, the magnitude of the falling slope of the second sustain signal RSUS is different from the magnitude of the rising slope of the second sustain signal RSUS. When the inductance of the inductor disposed on the voltage recovery path is more than the inductance of the inductor disposed on the voltage supply path, the magnitude of the rising slope of the second sustain signal RSUS is less than from the magnitude of the falling slope of the second sustain signal RSUS.

The first voltage supply unit 1120 includes a third control switch S3. A turn-on operation of the third control switch S3 occurs the supplying of a first sustain voltage Vs generated by a first sustain voltage source (not illustrated) to the scan electrode or the sustain electrode.

The ground controller 1170 causes the scan electrode or the sustain electrode to be grounded. The ground controller 1170 includes a ground path formation diode D1 and a fortieth control switch S40. The ground path formation diode D1 and the fortieth control switch S40 are connected in parallel to each other.

The path forming unit 1130 includes a fourth control switch S4. A turn-on operation of the fourth control switch S4 occurs the formation of a supply path of the second sustain signal RSUS and a ground path of the scan electrode or the sustain electrode.

The driver may further include a second voltage supply unit 1160. The second voltage supply unit 1160 includes a thirtieth control switch S30. A turn-on operation of the thirtieth control switch S30 occurs the supplying of a second sustain voltage −VRS to the scan electrode or the sustain electrode. The second voltage supply unit 1160 may be omitted.

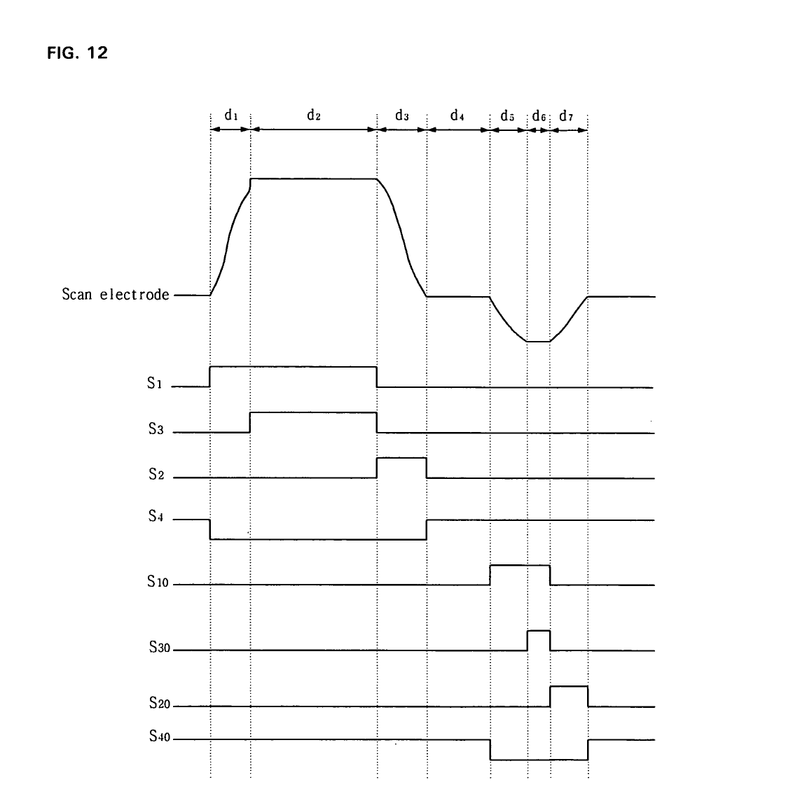

FIG. 12 illustrates an operation of a driver of the plasma display apparatus according to one embodiment.

During a period d1, the first control switch S1 of the first supply unit 1102 and the fortieth control switch S40 of the ground controller 1170 are turned on, and the second control switch S2, the third control switch S3, the tenth control switch S10, the twentieth control switch S20, the fourth control switch S4, and the thirtieth control switch S30 are turned off.

A current path passing through the first voltage storing unit 1101, a first node n1, a first supply unit 1102, a second node n2, the first resonance 1110, and a third node n3 is formed. Accordingly, LC resonance using the first resonance inductor L1 is formed such that energy stored in the first voltage storing unit 1101 is supplied to the scan electrode or the sustain electrode.

If energy corresponding to a voltage of 0.5Vs is stored in the first voltage storing unit 1101, a voltage of the scan electrode or the sustain electrode rises to the first sustain voltage Vs during the period d1.

A peaking voltage component of a negative polarity is removed through a turn-on operation of the fortieth control switch S40. The fortieth control switch S40 remains in a turn-on state during a period when the second sustain signal RSUS is not supplied such that a peaking voltage component of a negative polarity is removed.

During a period d2, the third control switch S3 is turned on. This results in the supplying of the first sustain voltage Vs to the scan electrode or the sustain electrode through the third node n3. Therefore, the voltage of the scan electrode or the sustain electrode is maintained at the first sustain voltage Vs.

During a period d3, the second control switch S2 is turned on in a turn-off state of the third control switch S3 and the first control switch S1.

A current path passing through the scan electrode or the sustain electrode, the third node n3, the first resonance unit 1110, the second node n2, the first voltage recovery unit 1103, the first node n1, and the first voltage storing unit 1101 is formed. Thus, LC resonance using the first resonance unit 1110 is formed such that the energy recovered from the scan electrode or the sustain electrode is stored in the first voltage storing unit 1101. The voltage of the scan electrode or the sustain electrode falls from the first sustain voltage Vs to the ground level voltage GND.

After a period d4, the fourth control switch S4 is turned on. The second control switch S2 may remain in a turn-on state, or may be turned off.

The ground level voltage GND is supplied to the scan electrode or the sustain electrode. Thus, the voltage of the scan electrode or the sustain electrode is maintained at the ground level voltage GND.

The first sustain signal SUS is supplied to the scan electrode or the sustain electrode through the above-described switch operations.

During a period d5, the tenth control switch S10 is turned on and the fortieth control switch S40 is turned off.

Thus, a current path passing through the scan electrode or the sustain electrode, the third node n3, the path forming unit 1130, a sixth node n6, the second resonance unit 1150, the second supply unit 1142, and the second voltage storing unit 1141 is formed.

LC resonance using the second resonance inductor L2 is formed such that the energy stored in the second voltage storing unit 1141 is supplied to the scan electrode or the sustain electrode. Since the second voltage storing unit 1141 stores energy corresponding to a negative voltage, the voltage of the scan electrode or the sustain electrode gradually falls.

During a period d6, the thirtieth control switch S30 is turned on. A second sustain voltage −VRS is supplied to the scan electrode or the sustain electrode through the sixth node n6 and the third node n3.

During a period d7, the tenth control switch S10 and the thirtieth control switch S30 are turned off, and the twentieth control switch S20 is turned on.

Accordingly, a current path passing through the second voltage storing unit 1141, the fourth node n4, the second voltage recovery unit 1143, the fifth node n5, the second resonance unit 1150, the sixth node n6, the path forming unit 1130, the third node n3, and the scan electrode or the sustain electrode is formed.

LC resonance using the second resonance inductor L2 is formed such that the energy recovered from the scan electrode or the sustain electrode is stored in the second voltage storing unit 1141. Since the second voltage storing unit 1141 recovers energy corresponding to a negative voltage from the scan electrode or the sustain electrode, the voltage of the scan electrode or the sustain electrode gradually rises.

The second sustain signal RSUS is supplied to the scan electrode or the sustain electrode through the above-described switch operations.

The driver 110 of FIG. 1 may supply a first sustain signal alternately having a positive polarity and a negative polarity to one of the scan electrode and the sustain electrode, may supply a second sustain signal alternately having a positive polarity and a negative polarity to the other electrode.

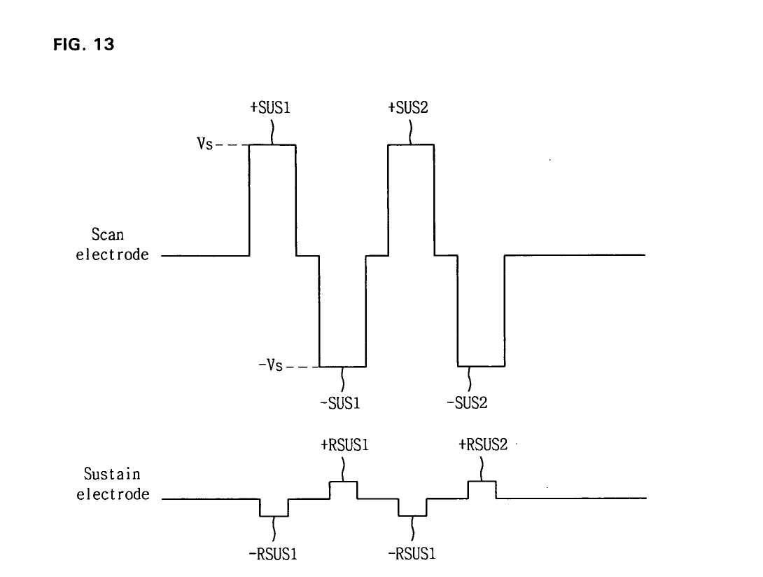

FIG. 13 illustrates a first sustain signal alternately and a second sustain signal which a driver of the plasma display apparatus according to one embodiment supplies.

As illustrated in FIG. 13, the driver 110 of FIG. 1 alternately supplies first sustain signals (+SUS1 and +SUS2) of a positive polarity and first sustain signals (−SUS1 and −SUS2) of a negative polarity to the scan electrode. The driver 110 of FIG. 1 alternately supplies second sustain signals (−RSUS1 and −RSUS2) of a negative polarity and second sustain signals (−+RSUS1 and +RSUS2) of a positive polarity to the sustain electrode.

A magnitude of the highest voltage of the first sustain signals (+SUS1 and +SUS2) of the positive polarity and a magnitude of the lowest voltage of the first sustain signals (−SUS1 and −SUS2) of the negative polarity are equal to a magnitude of the highest voltage Vs of the first sustain signal of FIG. 4. Therefore, a sustain discharge occurs. The sustain discharge is maintained due to the second sustain signals (−RSUS1 and −RSUS2) of the negative polarity and the second sustain signals (+RSUS1 and +RSUS2) of the positive polarity.

A magnitude of a rising slope and a magnitude of a falling slope of the second sustain signal are less than a magnitude of a rising slope and a magnitude of a falling slope of the first sustain signal, respectively.

The lowest voltage of the first sustain signals (−SUS1 and −SUS2) of the negative polarity may range from −180V to −120V. A magnitude of the highest voltage of the second sustain signals (+RSUS1 and +RSUS2) of the positive polarity is substantially equal to the highest voltage Vd of the data signal of FIG. 4. Since the lowest voltage of the first sustain signals (−SUS1 and −SUS2) of the negative polarity and the highest voltage of the second sustain signals (+RSUS1 and +RSUS2) of the positive polarity were illustrated and described in FIG. 6, a description thereof is omitted.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plasma display panel including a first electrode and a second electrode; and
a driver that supplies a first sustain signal of a first polarity to the first electrode during a signal supply period, and supplies a second sustain signal of a second polarity to the second electrode during at least a portion of the signal supply period,
wherein a magnitude of a rising slope and a magnitude of a falling slope of the second sustain signal are less than a magnitude of a rising slope and a magnitude of a falling slope of the first sustain signal, respectively.

2. The plasma display apparatus of claim 1, wherein the width of the second sustain signal is less than the width of the first sustain signal.

3. The plasma display apparatus of claim 1, wherein a supply time point of the second sustain signal is later than a supply time point of the first sustain signal, and a time interval between the supply time point of the first sustain signal and the supply time point of the second sustain signal is equal to or more than 50 μs.

4. The plasma display apparatus of claim 3, wherein a supply time point of the second sustain signal is later than a supply time point of the first sustain signal, and a time interval between the supply time point of the first sustain signal and the supply time point of the second sustain signal is equal to or more than 100 μs.

5. The plasma display apparatus of claim 1, wherein the highest voltage of the first sustain signal ranges from 120V to 180V.

6. The plasma display apparatus of claim 1, wherein the lowest voltage of the first sustain signal ranges from −180V to −120V.

7. The plasma display apparatus of claim 1, wherein the lowest voltage of the second sustain signal ranges from −60V to −40V.

8. The plasma display apparatus of claim 1, wherein the highest voltage of the second sustain signal ranges from 40V to 60V.

9. The plasma display apparatus of claim 1, wherein the magnitude of the rising slope of the second sustain signal is different from the magnitude of the falling slope of the second sustain signal.

10. The plasma display apparatus of claim 9, wherein the magnitude of the rising slope of the second sustain signal is less than the magnitude of the falling slope of the second sustain signal.

11. The plasma display apparatus of claim 1, further comprising a third electrode receiving a data signal,
wherein a magnitude of the lowest voltage of the second sustain signal is substantially equal to a magnitude of the highest voltage of the data signal.

12. The plasma display apparatus of claim 1, wherein the driver supplies a third sustain signal of the first polarity to one electrode of the first electrode and the second electrode, and supplies a ground level voltage to the other electrode.

13. The plasma display apparatus of claim 1, wherein the driver supplies the first sustain signal and the second sustain signal in a first subfield of a frame, and
the driver supplies a third sustain signal of the first polarity to one of the first electrode and the second electrode, and supplies a ground level voltage to the other electrode in a second subfield of the frame.

14. The plasma display apparatus of claim 13, wherein the number of first sustain signals supplied during a sustain period of the first subfield is smaller than the number of third sustain signals supplied during a sustain period of the second subfield.

15. The plasma display apparatus of claim 1, wherein the driver includes
a first energy recovery unit that recovers a first voltage of the first polarity from one electrode of the first electrode and the second electrode, and supplies the first voltage to one electrode,
a first resonance unit that forms resonance when recovering or supplying the first voltage from or to one electrode,
a first voltage supply unit that supplies a sustain voltage to one electrode associated with the first energy recovery unit,
a second voltage supply unit that supplies the lowest voltage of the second sustain signal,
a second energy recovery unit that recover a second voltage of the second polarity from the other electrode or supplies the second voltage to the other electrode,
a second resonance unit that forms resonance when recovering or supplying the second voltage from or to the other electrode,
a ground controller that grounds the first electrode or the second electrode, and
a path forming unit that forms a supply path of the second sustain signal and a supply path of a ground level voltage.

16. The plasma display apparatus of claim 15, wherein the first resonance unit and the second resonance unit each include a first inductor and a second inductor, and
inductance of the second inductor is more than inductance of the first inductor.

17. The plasma display apparatus of claim 15, wherein the ground controller includes a diode whose a cathode terminal is grounded, and a switch connected in parallel to the diode.

18. The plasma display apparatus of claim 15, wherein the second resonance unit includes a recovery inductor for recovering the second voltage, and a supply inductor for supplying the second voltage, and
inductance of the supply inductor is less than inductance of the recovery inductor.

19. The plasma display apparatus of claim 1, wherein the driver alternately supplies the first sustain signal of the first polarity and a third sustain signal of the second polarity to the first electrode, and
the driver alternately supplies the second sustain signal of the second polarity and a fourth sustain signal of the first polarity to the second electrode.

20. A method of driving a plasma display apparatus including a first electrode and a second electrode, comprising:
supplying a first sustain signal of a first polarity to the first electrode during a signal supply period; and
supplying a second sustain signal of a second polarity to the second electrode during at least a portion of the signal supply period,
wherein a magnitude of a rising slope and a magnitude of a falling slope of the second sustain signal are less than a magnitude of a rising slope and a magnitude of a falling slope of the first sustain signal, respectively.
